(19) United States
(12) Patent Application Publication
(10) Pub. No.: US 2015/0264267 A1
(43) Pub. Date: Sep. 17, 2015

(54) METHOD FOR GUIDING SHOOTING LOCATION OF ELECTRONIC DEVICE AND APPARATUS THEREFOR

(71) Applicant: Samsung Electronics Co., Ltd., Gyeonggi-do (KR)

(72) Inventors: Kyungmin PARK, Gyeonggi-do (KR); Jaejin LEE, Seoul (KR)

(21) Appl. No.: 14/620,552

(22) Filed: Feb. 12, 2015

(30) Foreign Application Priority Data
Mar. 12, 2014 (KR) 10-2014-0029138

(51) Int. Cl. H04N 5/232; H04N 5/235

(52) U.S. Cl. CPC H04N 5/23293; H04N 5/23203; H04N 5/2351; H04N 5/23222; H04N 2101/00

(57) ABSTRACT

A method and apparatus for guiding a camera shooting location. A subject is shot with a camera of the electronic device, and the device identifies whether an amount of incident light measured by a sensor of the camera is greater than a predetermined threshold value. The preview image is displayed along with recommended shooting location information if the amount of incident light amount is greater than the predetermined threshold value. A sensor unit has an illumination sensor configured to measure a sunlight amount, and a gyroscope sensor and an orientation sensor configured to measure a shooting direction of the camera. A processor controls a wireless communication unit including a GPS for measuring the locations of the electronic device, subject, and Sun. Recommended shooting location information is displayed informing where to move to shoot the subject if the incident light amount is greater than the predetermined threshold value.

### CLAIM OF PRIORITY

This application claims the benefit of priority under 35 U.S.C. §119(a) from a Korean patent application filed on March 12, 2014 in the Korean Intellectual Property Office and assigned Serial No. 10-2014-0029138, the entire disclosure of which is hereby incorporated by reference in its entirety.

### BACKGROUND

1. Field of the Disclosure

The present disclosure relates to a method for guiding a shooting location of a camera or camera module in an electronic device and an apparatus therefor.

2. Description of the Related Art

Many electronic devices used for communication often include a camera, typically embodied as a camera module, and a user may photograph a subject by using the camera of an electronic device in various environments. In the case of outdoor photography through the use of an electronic device, a subject may be sometimes photographed in a backlight condition due to incident sunlight into the camera. The photographing in a back light condition may be avoided if the locations of the Sun, subject and electronic device are correctly figured out.

### SUMMARY

Aspects of the present disclosure are to address at least some of the above mentioned problems and/or disadvantages to provide at least some of the advantages described below. Accordingly, an aspect of the present disclosure is to provide a method for avoiding a photo taken in a back light condition by calculating locations of the sun, subject, and electronic device so that an optimum shooting location may be taken. Another aspect of the present disclosure is to provide an apparatus for avoiding a photo taken in a back light condition.

In accordance with an aspect of the present disclosure, a method for guiding a shooting location of an electronic device is disclosed. The method includes: capturing an image of a subject with a camera of the electronic device, identifying whether an amount of incident light measured by a sensor of the camera is greater than a predetermined threshold value, and displaying recommended shooting (capturing) location information with a preview image if the amount of incident light is greater than the predetermined threshold value.

In accordance with another aspect of the present disclosure, an apparatus for guiding a shooting location of an electronic device is disclosed. The apparatus includes: an input unit including a camera in the electronic device configured to capture an image of a subject; a memory including an application configured to drive the camera; a display unit including a display module configured to display a shooting (capturing) location of the subject; a sensor unit including an illumination sensor configured to measure a sunlight amount, and a gyroscope sensor and an orientation sensor configured to measure a shooting direction of the camera; and a processor configured to control a wireless communication unit including a GPS for measuring the locations of the electronic device, subject, and sun. The processor includes a shooting location obtaining module which captures an image of a subject with the camera of the electronic device, identifies whether an amount of incident light measured by a sensor of the camera is greater than a predetermined threshold value, and controlling a display of recommended shooting location information along with a preview image if the amount of incident light is greater than the predetermined threshold value.

The method for guiding a shooting location of an electronic device and an apparatus therefor according to various embodiments of the present disclosure enables a user to avoid a photograph taken in a back light condition by displaying information for an optimum shooting (photographing) location.

### BRIEF DESCRIPTION OF THE DRAWINGS

The above and other aspects, features, and advantages of certain embodiments of the present disclosure will become more apparent to a person of ordinary skill in the art from the following description taken in conjunction with the accompanying drawings, in which:

FIG. 1 is a block diagram illustrating a network environment including an electronic device according to various embodiments of the present disclosure;

FIG. 2 is a block diagram illustrating a configuration of an electronic device according to various embodiments of the present disclosure;

FIG. 3 is a block diagram illustrating a configuration of an electronic device according to various embodiments of the present disclosure;

FIG. 4 is a flow chart illustrating a procedure of displaying a shooting location according to various embodiments of the present disclosure;

FIG. 5 is a block diagram illustrating a configuration according to various embodiments of the present disclosure;

FIG. 6A, FIG. 6B, and FIG. 6C are drawings illustrating examples of displaying a shooting location according to various embodiments of the present disclosure; and

FIG. 7 is a drawing illustrating a method for displaying a shooting location according to various embodiments of the present disclosure.

### DETAILED DESCRIPTION

Hereinafter, embodiments of the present invention will be described in detail with reference to the accompanying drawings. It will be easily appreciated to those skilled in the art that various modifications, additions and substitutions are possible from the embodiment of the present disclosure, and the scope of the invention should not be limited to the following embodiments. The embodiments of the present disclosure are provided such that those skilled in the art completely understand the disclosure. In the drawings, the same or similar elements are denoted by the same reference numerals even though they are depicted in different drawings.

The expressions such as “include” and “may include” which may be used in the present disclosure denote the presence of the disclosed functions, operations, and constituent elements and do not limit one or more additional functions, operations, and constituent elements. In the present disclosure, the terms such as “include” and/or “have” may be construed to denote a certain characteristic, number, step, operation, constituent element, component or a combination thereof, but may not be construed to exclude the existence of or a possibility of the addition of one or more other characteristics, numbers, steps, operations, constituent elements, components or combinations thereof.

In the present disclosure, the expression “and/or” includes any and all combinations of the associated listed words. For example, the expression “A and/or B” may include A, may include B, or may include both A and B.

In the present disclosure, expressions including ordinal numbers, such as “first” and “second,” etc., and/or the like, may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although for both of them the first user device and the second user device are user devices. For example, a first element could be termed a second element, and similarly, a second element could be also termed a first element without departing from the scope of the present disclosure. In the case where according to which a component is referred to as being “connected” or “accessed” to other component, it should be understood that not only the component is directly connected or accessed to the other component, but also another component may exist between the component and the other component. Meanwhile, in the case where according to which a component is referred to as being “directly connected” or “directly accessed” to other component, it should be understood that there is no component there between.

The terms used in the present disclosure are only used to describe specific various embodiments, and do not limit the present disclosure. Singular forms are intended to include plural forms unless the context clearly indicates otherwise.

Unless otherwise defined, all terms including technical and/or scientific terms used herein have the same meaning as commonly understood by one of ordinary skill in the art to which the disclosure pertains. In addition, unless otherwise defined, all terms defined in generally used dictionaries may not be overly interpreted.

The electronic device according to the embodiments of the present disclosure may be a device including a heart rate measuring function. For example, the electronic device corresponds to a combination of at least one of the followings: a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital audio player (e.g., MP3 player), a mobile medical device, a camera, or a wearable device. Examples of the wearable device are a head-mounted-device (HMD) (e.g., electronic eyeglasses), electronic clothing, an electronic bracelet, an electronic necklace, an “appcessory”, an electronic tattoo, a smart watch, etc.

The electronic device according to the embodiments of the present disclosure may be smart home appliances with a heart rate measuring function. Examples of the smart home appliances include but are not limited to a television (TV), a Digital Video Disk (DVD) player, an audio system, a refrigerator, an air-conditioner, a cleaning device, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, an electronic album, or the like.

The electronic device according to the embodiments of the present disclosure may include at least one of the following: medical devices (e.g., Magnetic Resonance Angiography (MRA), Magnetic Resonance Imaging (MRI), Computed Tomography (CT), a scanning machine, an ultrasonic scanning device, etc.), a navigation device, a Global Positioning System (GPS) receiver, an Event Data Recorder (EDR), a Flight Data Recorder (FDR), a vehicle infotainment device, an electronic equipment for ships (e.g., navigation equipment, gyrocompass, etc.), avionics, a security device, a head unit for vehicles, an industrial or home robot, an automatic teller's machine (ATM), a point of sales (POS) system, etc.

The electronic device according to the embodiments of the present disclosure may include at least one of the following: furniture or a portion of a building/structure, an electronic board, an electronic signature receiving device, a projector, various measuring instruments (e.g., a water meter, an electric meter, a gas meter and a wave meter), etc., which are equipped with a measuring function, respectively. The electronic device according to the embodiments of the present disclosure may also include a combination of the devices listed above. In addition, the electronic device according to the embodiments of the present disclosure may be a flexible device. It is obvious to those skilled in the art that the electronic device according to the embodiments of the present disclosure is not limited to the aforementioned devices.

Hereinafter, electronic devices according the embodiments of the present disclosure are described in detail with reference to the accompanying drawings. In the description, the term a ‘user’ may be referred to as a person or a device that uses an electronic device, e.g., an artificial intelligent electronic device.

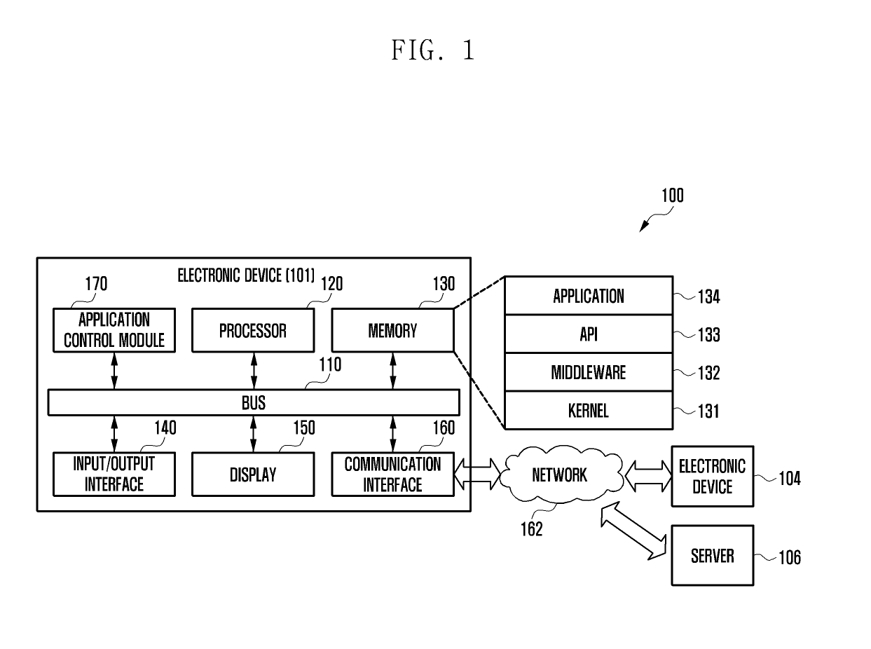

FIG. 1 illustrates a network environment 100 including an electronic device 101 according to an embodiment of the present disclosure. Referring now to FIG. 1, the electronic device 101 may include a bus 110, a processor 120, a non-transitory memory 130, an input/output (I/O) interface 140, a display 150, a communication interface 160 and an application control module 170.

The bus 110 may be a communication circuit that connects the aforementioned components as well as other items to each other and transfers data (e.g., control messages) between the components.

The processor 120, which maybe a microprocessor and comprises hardware that can include integrated circuitry configured for operation, may receive data addresses and/or instructions from the components (e.g., the memory 130, input/output interface 140, display 150, communication interface 160, application control module 170, etc.) via the bus 110, decode the data or instructions and perform corresponding operations or data processing according to the decoded instructions.

The memory 130 may store instructions or data transferred from/created in the processor 120 or the other components (e.g., the input/output interface 140, display 150, communication interface 160, application control module 170, etc.). The memory 130 may include programming modules, e.g., a kernel 131, middleware 132, application programming interface (API) 133, application module 134, etc. Each of the programming modules may be machine code, firmware, hardware or a combination thereof.

The kernel 131 may control or manage system resources (e.g., the bus 110, processor 120, memory 130, etc.) used to execute operations or functions of the programming modules, e.g., the middleware 132, API 133, and application module 134. The kernel 131 may also provide an interface that may access and control/manage the components of the electronic device 101 via the middleware 132, API 133, and application module 134.

The middleware 132 may enable the API 133 or application module 134 to perform data communication with the kernel 131. The middleware 132 may also perform control operations (e.g., scheduling, load balancing) for task requests transmitted from the application module 134 by methods, for example, a method for assigning the order of priority to use the system resources (e.g., the bus 110, processor 120, memory 130, etc.) of the electronic device 101 to at least one of the applications of the application module 134.

The application programming interface (API) 133 is an interface that enables the application module 134 to control functions of the kernel 131 or middleware 132. For example, the API 133 may include at least one interface or function (e.g., instruction) for file control, window control, character control, video process, etc.

In embodiments of the present disclosure, the application module 134 may include applications that are related to: SMS/MMS, email, calendar, alarm, health care (e.g., an application for measuring the blood sugar level, a workout application, etc.), environment information (e.g., atmospheric pressure, humidity, temperature, etc.), and so on. The application module 134 may be an application related to exchanging information between the electronic device 101 and the external electronic devices (e.g., an electronic device 104). The information exchange-related application may include a notification relay application for transmitting specific information to an external electronic device, or a device management application for managing external electronic devices.

For example, the notification relay application may include a function for transmitting notification information, created by the other applications of the electronic device 101 (e.g., SMS/MMS application, email application, health care application, environment information application, etc.), to an external electronic device (e.g., electronic device 104). In addition, the notification relay application may receive notification information from an external electronic device (e.g., electronic device 104) and provide the notification information to the user. The device management application may manage (e.g., to install, delete, or update) part of the functions of an external electronic device (e.g., electronic device 104) communicating with the electronic device 101, e.g., turning on/off the external electronic device, turning on/off part of the components of the external electronic device, adjusting the brightness (or the display resolution) of the display of the external electronic device, etc.; applications operated in the external electronic device; or services from the external electronic device, e.g., call service or messaging service, etc.

In embodiments of the present disclosure, the application module 134 may include applications designated according to attributes (e.g., type of electronic device) of the external electronic device (e.g., electronic device 104). For example, if the external electronic device is an MP3 player, the application module 134 may include an application related to music playback. If the external electronic device is a mobile medical device, the application module 134 may include an application related to health care. In an embodiment of the present disclosure, the application module 134 may include at least one of the following: an application designated in the electronic device 101 and applications transmitted from external electronic devices (e.g., server 106, electronic device 104, etc.).

The input/output interface 140 may receive instructions or data from the user via an input/output system (e.g., a sensor, keyboard or touch screen) and transfers them to the processor 120, memory 130, communication interface 160 or application control module 170 through the bus 110. For example, the input/output interface 140 may provide data corresponding to a user's touch input to a touch screen to the processor 120. The input/output interface 140 may receive instructions or data from the processor 120, memory 130, communication interface 160 or application control module 170 through the bus 110, and output them to an input/output system (e.g., a speaker or a display). For example, the input/output interface 140 may output voice data processed by the processor 120 to the speaker.

The display 150 may display information (e.g., multimedia data, text data, etc.) on the screen so that the user may view it.

The communication interface 160 may communicate between the electronic device 101 and an external system (e.g., an electronic device 104 or server 106). For example, the communication interface 160 may connect to a network 162 in wireless or wired mode and communicate with the external system. Wireless communication may include at least one of the following: Wireless Fidelity (Wi-Fi), Bluetooth (BT), near field communication (NFC), global positioning system (GPS) or cellular communication (e.g., LTE, LTE-A, CDMA, WCDMA, UMTS, Wi-Bro, GSM, etc.). Wired communication may include at least one of the following: a universal serial bus (USB), high definition multimedia interface (HDMI), recommended standard 232 (RS-232), plain old telephone service (POTS), etc.

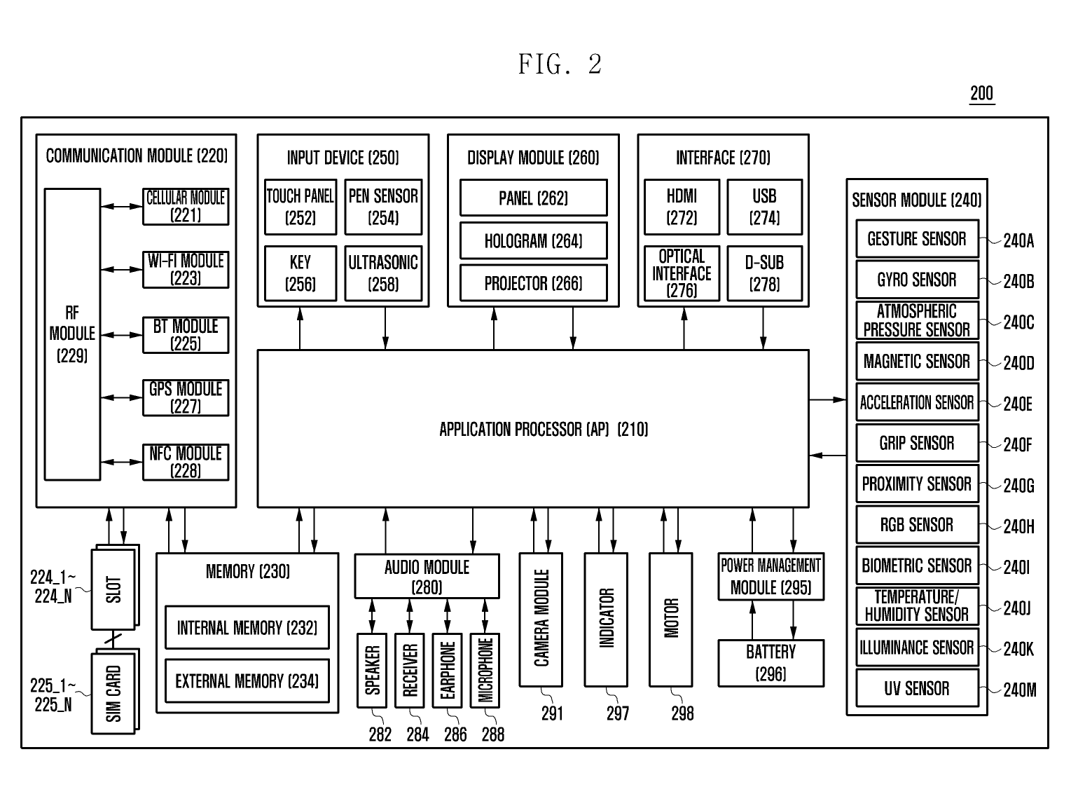

In an embodiment of the present disclosure, the network 162 may be a telecommunication network. The telecommunication network may include at least one of the following: a computer network, Internet, Internet of things, telephone network, etc. The protocol for communication between the electronic device 101 and the external system, e.g., transport layer protocol, data link layer protocol, or physical layer protocol, may be supported by at least one of the following: application module 134, API 133, middleware 132, kernel 131 and communication interface 160. The application control module 170 processes at least a portion of information obtained from other components such as a processor 120, memory 130, input/output interface 140, and communication interface 160, and provides it for a user in various methods. For example, the application control module 170 identifies information of components connected to the electronic device 101, stores the information of components in the memory 130, and executes the application 134 based on the connected components. More detailed information of the application control module 170 will be described referring to FIGS. 2 to 7.

FIG. 2 illustrates a schematic block diagram of an electronic device according to an embodiment of the present disclosure. The electronic device may be part or all of electronic device 101 as shown in FIG. 1. Referring to FIG. 2, the electronic device may include one or more processors of the application processor 210, a communication module 220, a subscriber identification module (SIM) card 225, a memory 230, a sensor module 240, an input system 250, a display module 260, an interface 270, an audio module 280, a camera module 291, a power management module 295, a battery 296, an indicator 297, and a motor 298.

The application processor (AP) 210 may control a number of hardware or machine code components connected thereto by executing the operation system or applications, process data including multimedia data, and perform corresponding operations. The AP 210 may be implemented with a system on chip (SoC). In an embodiment of the present disclosure, the AP 210 may further include a graphic processing unit (GPU).

The communication module 220 (e.g., communication interface 160) performs communication for data transmission/reception between the other electronic devices (e.g., an electronic device 104, server 106) that are connected to the electronic device (e.g., electronic device 101) via the network. In an embodiment of the present disclosure, the communication module 220 may include a cellular module 221, a Wi-Fi module 223, a Bluetooth (BT) module 225, a GPS module 227, an NFC module 228 and a radio frequency (RF) module 229.

The cellular module 221 may provide, for example, a voice call, a video call, an SMS or Internet service, etc., via a communication network (e.g., LTE, LTE-A, CDMA, WCDMA, UMTS, Wi-Bro, GSM, etc.). The cellular module 221 may perform identification or authentication for electronic devices in a communication network by using their subscriber identification module (e.g., SIM card 225). In an embodiment of the present disclosure, the cellular module 221 may perform part of the functions of the AP 210. For example, the cellular module 221 may perform part of the functions for controlling multimedia.

In an embodiment of the present disclosure, the cellular module 221 may include a communication processor (CP). The cellular module 221 may be implemented with, for example, a SoC. Although the embodiment of the present disclosure shown in FIG. 2 is implemented in such a way that the cellular module 221 (e.g., communication processor), the power management module 295, the memory 230, etc., are separated from the AP 210, it may be modified in such a way that the AP 210 includes at least part of those (e.g., cellular module 221).

In an embodiment of the present disclosure, the AP 210 or the cellular module 221 (e.g., communication processor) may load instructions or data transmitted from at least one of the following: non-volatile memory or other components, on a volatile memory and then process them. The AP 210 or the cellular module 221 may also store data in a non-volatile memory, which is transmitted from/created in at least one of the other components.

The Wi-Fi module 223, the BT module 225, the GPS module 227 and the NFC module 228 may include processors for processing transmission/reception of data, respectively. Although the embodiment of the present disclosure shown in FIG. 2 is implemented such that the cellular module 221, Wi-Fi module 223, BT module 225, GPS module 227, and NFC module 228 are separated from each other, the structure may be modified in such a way that part of those (e.g., two or more) are included in an integrated chip (IC) or an IC package. For example, part of the processors corresponding to the cellular module 221, Wi-Fi module 223, BT module 225, GPS module 227, and NFC module 228, e.g., a communication processor corresponding to the cellular module 221 and a Wi-Fi processor corresponding to the Wi-Fi 223, may be implemented with a SoC.

The radio frequency (RF) module 229 may transmit or receive data, e.g., RF signals. The RF module 229 includes hardware such as a transmitter, receiver, or a transceiver, a power amplifier module (PAM), a frequency filter, a low noise amplifier (LNA), etc. The RF module 229 may also include components for transmitting/receiving electromagnetic waves, e.g., conductors, wires, etc., via free space during wireless communication. Although the embodiment of the present disclosure shown in FIG. 2 is arranged such that the cellular module 221, Wi-Fi module 223, BT module 225, GPS module 227, and NFC module 228 share the RF module 229, the structure according to the present disclosure may be modified so that at least one of the aforementioned modules transmits or receives RF signals via a separate RF module.

The subscriber identification module (SIM) card 225 may be a card with a subscriber identification module (SIM). The SIM cards (225-1 through 225-N) may be fitted into a slot (224-1 through 224-N) of the electronic device. The SIM card 225 may include unique identification information, e.g., integrated circuit card identifier (ICCID), or subscriber information, e.g., international mobile subscriber identity (IMSI).

The memory 230 (e.g., memory 130) may include built-in memory 232 and/or external memory 234. The built-in memory 232 may include at least one of the following: volatile memory, e.g., dynamic RAM (DRAM), static RAM (SRAM), synchronous dynamic RAM (SDRAM), etc.; non-volatile memory, e.g., one time programmable ROM (OTPROM), programmable ROM (PROM), erasable and programmable ROM (EPROM), electrically erasable and programmable ROM (EEPROM), mask ROM, flash ROM, NAND flash memory, NOR flash memory, etc.

In an embodiment of the present disclosure, the built-in memory 232 may be a Sold State Drive (SSD). The external memory 234 may further include a flash drive, e.g., compact flash (CF), secure digital (SD), micro-secure digital (micro-SD), mini-secure digital (mini-SD), extreme digital (XD), a memory stick, etc., just to name a few non-limiting possibilities. The external memory 234 may be functionally connected to the electronic device via various types of interface. In an embodiment of the present disclosure, the electronic device 101 may further include storage devices (or storage media) such as hard drives.

The sensor module 240 may measure a physical quantity or sense various operative states of the electronic device 101 and convert the measured or sensed data to electrical signals. The sensor module 240 may include at least one of the following: gesture sensor 240A, gyro sensor 240B, atmospheric pressure sensor 240C, magnetic sensor 240D, acceleration sensor 240E, grip sensor 240F, proximity sensor 240G, color sensor 240H (e.g., red-green-blue (RGB) sensor), biosensor 240I, temperature/humidity sensor 240J, luminance sensor 240K, and ultra-violet (UV) sensor 240M, just to name a few non-limiting possibilities.

The biosensor 240I may be a heart rate (HR) measuring sensor. The HR measuring sensor may be equipped with an LED and a photodiode. The LED serves as a light source for illuminating a user's skin with light. The photodiode serves to detect part of perfused light from the skin. The detected light is amplified by an amplifier, converted into digital signals via ADC, and transferred to a processor.

The acceleration sensor 240E may sense acceleration information and transfer it to the processor. The AP 210 executes an algorithm for compensating an influence according to information regarding motion sensed by the acceleration sensor and calculates an HR by using the digitally converted input signals. The AP 210 calculates HR 1 and HR 2, compares HR 1 with HR 2, determines a resultant HR, and outputs the resultant HR.

The sensor module 240 may also include an e-nose sensor, electromyography (EMG) sensor, an electroencephalogram (EEG) sensor, an electrocardiogram (ECG) sensor, an Infra-Red (IR) sensor, a fingerprint sensor, an iris sensor, etc. The sensor module 240 may further include a control circuit for controlling one or more sensors.

The input system 250 may include a touch panel 652, a pen sensor 254 (i.e., a digital pen sensor), a key 256 and an ultrasonic input system 258. The touch panel 252 may sense touches in at least one of the following: capacitive sensing mode, pressure sensing mode, infrared sensing mode, and ultrasonic sensing mode. The touch panel 252 may further include a control circuit. When the touch panel 252 is designed to operate in capacitive sensing mode, the touch panel may sense mechanical/physical touches or proximity of an object. The touch panel 252 may further include a tactile layer. In such a case, the touch panel 252 may provide tactile feedback to the user.

The pen sensor 254 (i.e., digital pen sensor) may be implemented in the same or similar way as receiving a user's touch input or by using a separate recognition sheet. The key 256 may include mechanical buttons, optical keys or a key pad. The ultrasonic input system 258 is a device that may sense sounds via a microphone 288 of the electronic device 101 by using an input tool for generating ultrasonic signals and may check the data. The ultrasonic input system 258 may also sense signals in wireless mode. In an embodiment of the present disclosure, the electronic device 101 may receive a user's inputs from an external system (e.g., a computer or server) via the communication module 220.

The display 260 (e.g., display 150) may include a panel 262, a hologram unit 264, or a projector 266. The panel 262 may be implemented with a Liquid Crystal Display (LCD), Active Matrix Organic Light Emitting Diodes (AMOLEDs), or the like. The panel 262 may be implemented in a flexible, transparent, or wearable form. The panel 262 may form a single module with the touch panel 252. The hologram unit 264 shows a three-dimensional image in the air using an interference of light. The projector 266 may display images, for example, by projecting light on a screen. The screen may be placed, for example, inside or outside the electronic device 101. In an embodiment of the present disclosure, the display module 260 may further include a control circuit for controlling the panel 262, the hologram unit 264, or the projector 266.

The interface 270 may include a high-definition multimedia interface (HDMI) 272, a universal serial bus (USB) 274, an optical interface 276, a D-subminiature (D-sub) 278, etc. The interface 270 may also be included in the communication interface 160 shown in FIG. 1. The interface 270 may also include a mobile high-media card (MHL) interface, a secure digital (SD) card, a multi-media card (MMC) interface, an infrared data association (IrDA) standard interface, or the like.

The audio module 280 converts between audios and electrical signals. At least part of the components in the audio module 280 may be included in the input/output interface 140 shown in FIG. 1. The audio module 280 may process audios output from/input to, for example, a speaker 282, a receiver 284, earphones 286, a microphone 288, etc.

The camera module 291 may capture still images or moving images. In an embodiment of the present disclosure, the camera module 291 may include one or more image sensors (e.g., on the front side and/or the back side), a lens, an image signal processor (ISP), a flash (e.g., an LED or a xenon lamp), or the like.

The power management module 295 may manage electric power supplying to the electronic device 101. The power management module 295 may include a power management integrated circuit (PMIC), a charger integrated circuit (IC), a battery or fuel gauge, etc., just to name some possibilities.

The PMIC may be implemented in the form of an IC chip or an SoC chip. Charging electric power may be performed in wired or wireless mode. The charger IC may charge a battery, preventing input over-voltage or input over-current from inputting to the battery from a charger. In an embodiment of the present disclosure, the charger IC may be implemented with a wired charging type and/or a wireless charging type. Examples of the wireless charging type of charger IC are a magnetic resonance type, a magnetic induction type, an electromagnetic type, etc. If the charger IC is implemented with a wireless charging type, it may include an additional circuit for wireless charging, e.g., a coil loop, a resonance circuit, a rectifier, etc.

With continued reference to FIG. 2, the battery gauge may measure the residual amount of battery 296, the level of voltage, the level of current, temperature during the charge. The battery 296 charges electric power and supplies it to the electronic device 101. The battery 296 may include a rechargeable battery or a solar battery.

The indicator 297 shows states of the electronic device 101 or of the parts (e.g., AP 210), e.g., a booting state, a message state, a recharging state, etc. The motor 298 converts an electrical signal into a mechanical vibration. Although it is not shown, the electronic device 101 may include a processor for supporting a mobile TV, e.g., a graphic processing unit (GPU). The mobile TV supporting processor may process media data that comply with standards of digital multimedia broadcasting (DMB), digital video broadcasting (DVB), media flow, etc.

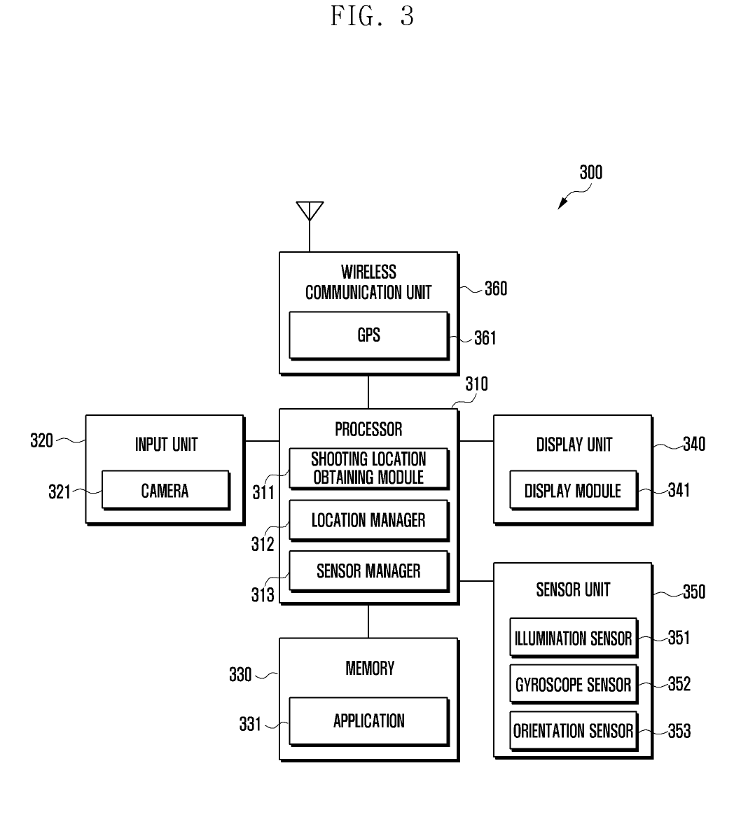

Each of the elements/units of the electronic device according to the present disclosure may be implemented with one or more components, and be called different names according to types of electronic devices. The electronic device according to the present disclosure may include at least one element described above. The electronic device may be modified in such a way as to: remove part of the elements or include new elements. In addition, the electronic device according to the present disclosure may also be modified in such a way that parts of the elements are integrated into one entity that performs their original functions. FIG. 3 is a block diagram illustrating a configuration of an electronic device according to various embodiments of the present disclosure.

Referring now to FIG. 3, the electronic device may include a processor 310, input unit 320, memory 330, display unit 340, sensor unit 350, and wireless communication unit 360.

The processor 310 may include a shooting location obtaining module 311, a location manager 312, and a sensor manager 313.

The shooting location obtaining module 311 receives data regarding: a subject whose image is to be captured, an electronic device, and the sun from the location manager 312 and the sensor manager 313. The shooting location obtaining module 311 obtains an optimal location for avoiding a backlight projecting into an image about to be captured if the backlight is identified from the received data. The shooting location obtaining module 311 controls the display module 341 with the obtained optimal location, and displays information of the current location and a recommended shooting location together with a preview image.

The location manager 312 detects locations of the electronic device 300, subject, and sun by controlling a GPS 361. The location manager 312 transmits information of the detected locations of the electronic device 300, subject, and sun to the shooting location obtaining module 311.

The sensor manager 313 detects a light amount received from the sun by controlling an illumination sensor 351. The sensor manager 313 detects a shooting direction of the electronic device 300 (i.e. shooting direction of camera) from received data by controlling a gyroscope sensor 352 and an orientation sensor 353.

The input unit 320 may be an input device 250 of FIG. 2.

The memory 330 may also be a memory 230 of FIG. 2. The memory 330 may include an application 331. The application 331 may be an application 134 of FIG. 1.

The display unit 340 may include a display module 341. The display module 341 may be a display module 260 of FIG. 2.

The sensor unit 350 may be a sensor module 240 of FIG. 2. The sensor unit 350 may include an illumination sensor 351 (240K), gyroscope sensor 352 (240B), and orientation sensor 353.

The wireless communication unit 360 may be a communication module 220 of FIG. 2. The wireless communication unit 360 may include a GPS 361. The GPS 361 may be a GPS module 227 of FIG. 2.

The electronic device according to various embodiments of the present disclosure may include an input unit having a camera in the electronic device configured to shoot a subject; a memory including an application configured to drive the camera; a display unit including a display module configured to display a shooting location of the subject; a sensor unit including an illumination sensor configured to measure an amount of sunlight, and a gyroscope sensor and an orientation sensor configured to measure a shooting direction of the camera; and a processor configured to control a wireless communication unit including a GPS for measuring the locations of the electronic device, subject, and sun. The processor may include a shooting location obtaining module which shoots a subject with the camera of the electronic device, identifies whether an amount of incident light measured by a sensor of the camera is greater than a predetermined threshold value, and controlling to display recommended shooting location information with a preview image if the incident light amount is greater than the predetermined threshold value.

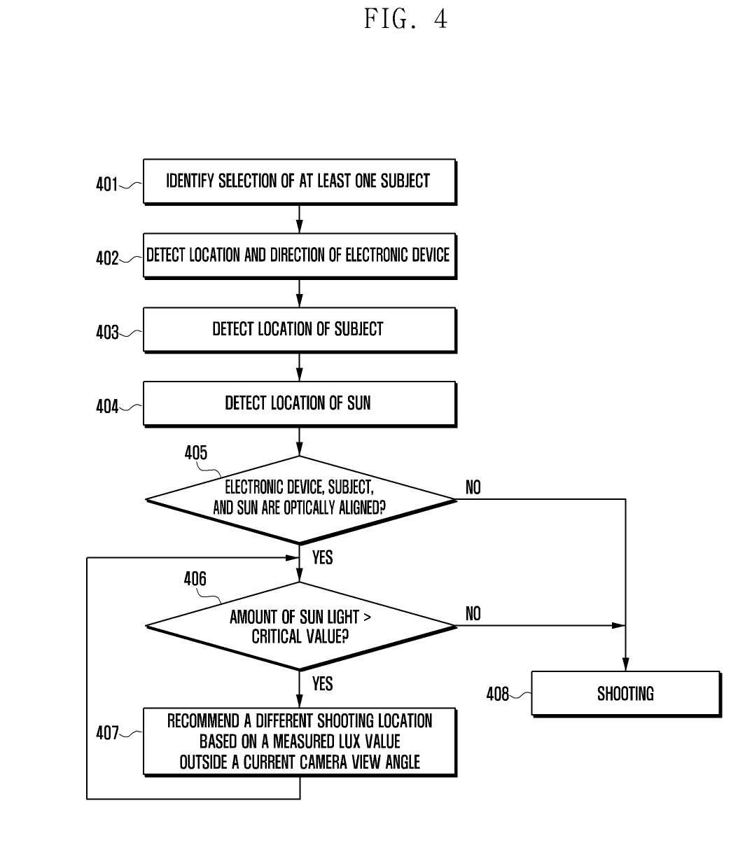

FIG. 4 is a flow chart illustrating an example of an operative procedure of displaying a shooting location according to various embodiments of the present disclosure.

Referring now to FIG. 4, at operation 401 the processor 310 identifies at least one user's subject selection. The processor 310 displays the selected subject and a mark indicating the subject according to the user's subject selection.

At operation 402, the location manager 312 identifies the current location of the electronic device 300 by using a radio signal for measuring a location transmitted from a GPS satellite (not shown). The sensor manager 313 detects a direction of the electronic device 300 by controlling the gyroscope sensor 352 and orientation sensor 353 of the sensor unit 350.

At operation 403, the processor 310 may detect a location of the selected subject whose image is to be captured. The processor 310 may calculate a distance between the electronic device 300 and a subject, and distances between subjects if a plurality of subjects exists at operation 403. The electronic device 300 may calculate the distance by using a phase difference detecting sensor. Further, the distance may be calculated by using an additional ultrasonic sensor (for example, ultrasonic input device 258 of FIG. 2) or an infrared sensor.

At operation 404, the processor 310 may detect a location of the Sun. The processor 310 detects the location of the sun by controlling the wireless communication unit 360 and receiving a radio signal for measuring a location transmitted from the GPS 361.

At operation 405, the shooting location obtaining module 311 of the electronic device 300 identifies whether the electronic device 300, subject, and sun detected at operations 402 to 404 are located so as to be optically aligned.

At operation 408, if the electronic device 300, subject, and sun detected at operations 402 to 404 are not optically aligned, the shooting location obtaining module 311 of the electronic device 300 shoots the selected subject.

At operation 405, if the electronic device 300, subject, and sun detected are optically aligned, the shooting location obtaining module 311 of the electronic device 300 proceeds to operation 406.

At operation 406, sensor manager 313 measures a lux value of the sunlight by controlling the illumination sensor 351. The sensor manager 313 may identify the lux value of the sunlight as the maximum value by controlling the illumination sensor 351. The maximum value may be a threshold value for identifying a backlight later on.

If at operation 406, the lux value of the sunlight is identified to be less than the threshold value, the shooting location obtaining module 311 may proceed to operation 408 so that a shooting may be performed even though a shadow exists on the subject and electronic device 300, or an indoor condition is detected because the electronic device, subject, and sun are optically aligned. Alsom at operation 408, the processor 310 shoots the selected subject.

However, if at operation 406 the lux value of the sunlight is identified to be greater than the threshold value, then at operation 407 a shooting location obtaining module 311 may find a location without a backlight by measuring a lux value of the light with the illumination sensor 351 from the outside of a camera view angle. After operation 407, the method would proceed back to operation 406 to determine whether or not to capture the image of the subject. The recommended location may have either no backlight or an amount less than the threshold value.

In order to recommend a location without a backlight, the shooting location obtaining module 311 may find an optimal location for shooting the selected subject by using location and direction data measured at operation 402 to 404. The shooting location obtaining module 311 may control the display module 341 to display a map indicating the current location and a recommended shooting location. While the electronic device 300 is moving to the recommended shooting location, the sensor manager 313 may measure a lux value by controlling the illumination sensor 351.

If the lux value received from the illumination sensor 351 becomes less than the threshold value while the electronic device 300 is moving to the recommended shooting location, the shooting location obtaining module 311 may control the display module 341 to display a shooting possibility notice with the preview image.

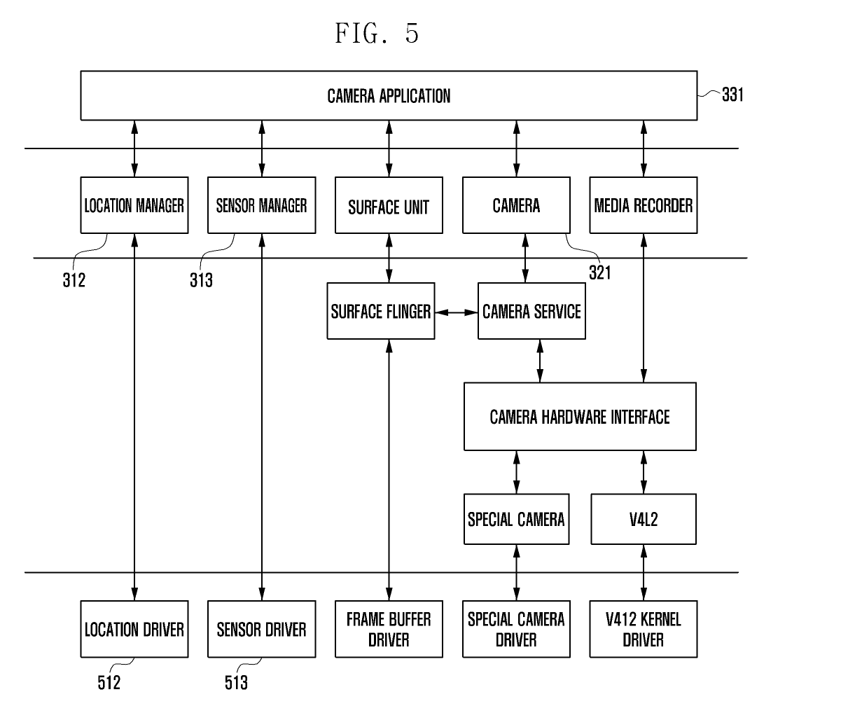

FIG. 5 is a block diagram illustrating a configuration of software according to various embodiments of the present disclosure.

Referring now to FIG. 5, the configuration may be largely divided into 4 layers of application 331, framework, HAL (Hardware Abstraction Layer), and driver. An application such as a camera application may be included in the application layer. The framework layer may include a location manager 312, sensor manager 313, surface view, camera, and media recorder.

The location manager 312 receives location data transmitted from the GPS 361 through a location driver 512. The location manager 312 may transmit the received location to a camera application. The sensor manager 313 may receive an amount of light transmitted from the illumination sensor 351 through a sensor driver 513.

Further, sensor manager 313 may receive location data from the gyroscope sensor 352 and orientation sensor 353a through the sensor driver 513. The HAL layer may include a surface flinger, camera service, camera hardware interface, special camera, and V4L2 (Video for Linux2). The driver layer may include a location driver 512, sensor driver 513, frame buffer driver, special camera driver, and V4L2 kernel driver.

The location driver 512 may transmit the location data received from the GPS 361 to the location manager 312. The sensor driver 513 may transmit the amount of light received from the illumination sensor 351 to the sensor manager 313. The sensor driver 513 may transmit the location data received from the gyroscope sensor 352 and orientation sensor 353 to the sensor manager 313.

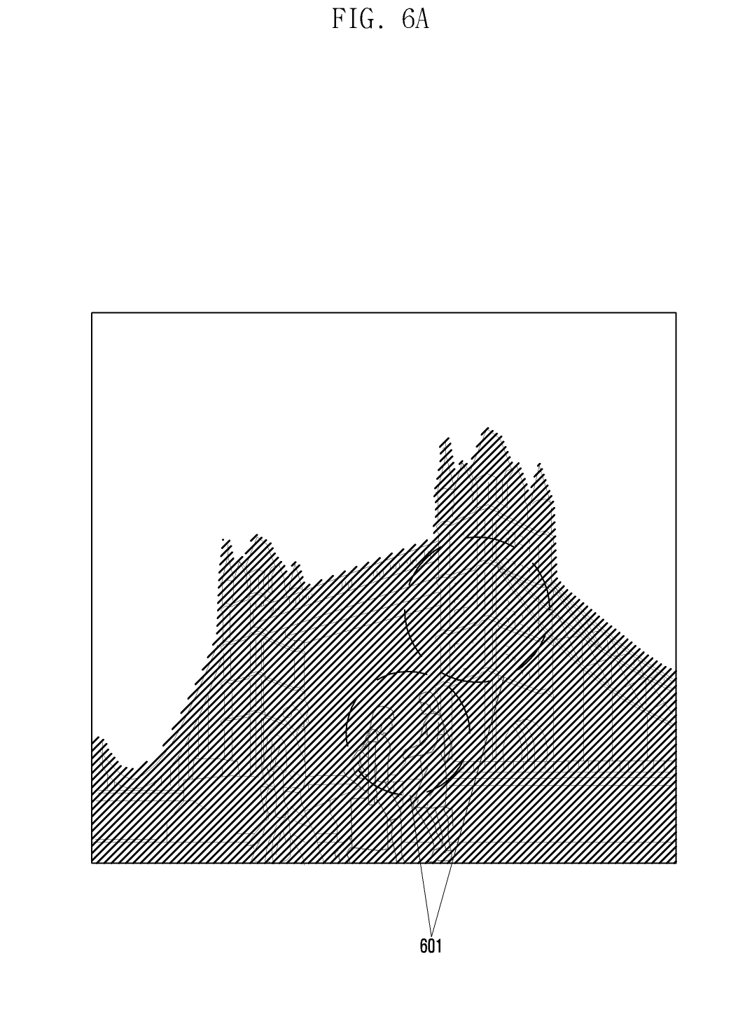

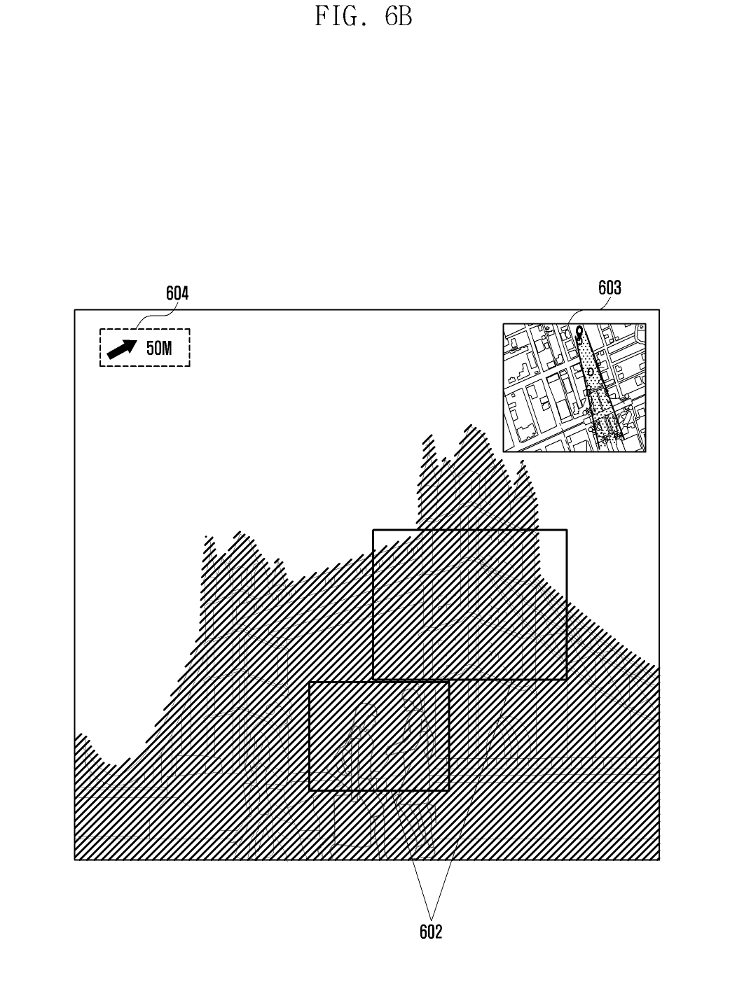

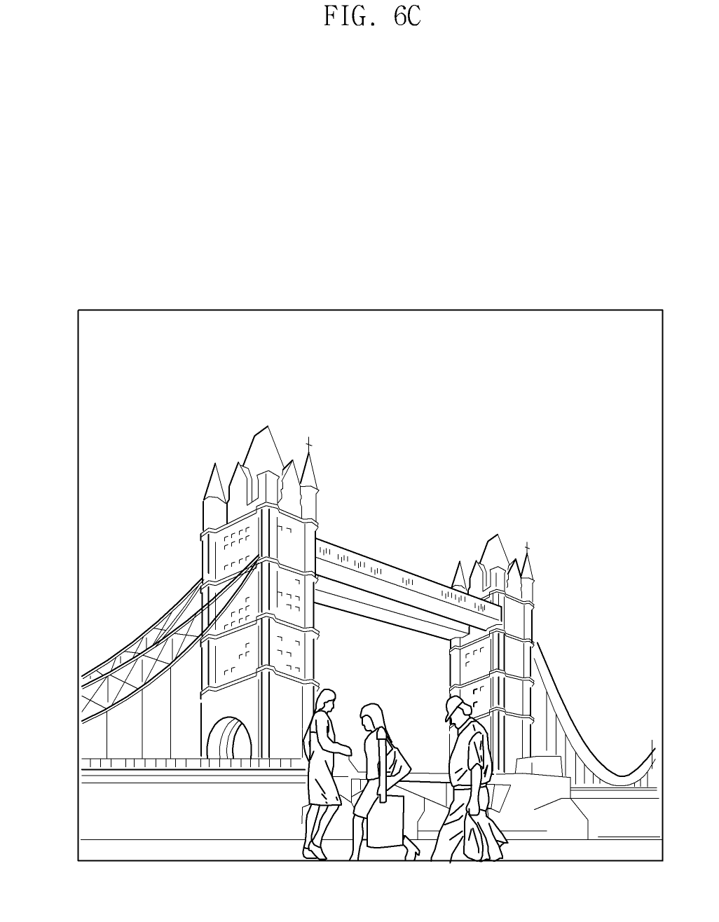

FIGS. 6A, 6B, and 6C are drawings illustrating examples of displaying a shooting location according to various embodiments of the present disclosure.

Referring now to FIG. 6A, the processor 310 may identify at least one user's subject selection 601 for shooting while the camera 321 operates.

Referring now to FIG. 6B, the processor 310 may control the display module 341 to display a mark 602 on the selected subject according to the identification of the user selection 601.

Here, the location manager 312 may receive the current location of the electronic device 300 from the GPS 361 and identify the locations of the selected subject and the Sun. Further, a distance between the electronic device 300 and the selected subject and distances between subjects may be identified through a phase difference detecting sensor. The sensor manager 313 may identify the current orientation of the electronic device 300 through the gyroscope sensor 352 and orientation sensor 353.

The shooting location obtaining module 311 may identify whether a subject, electronic device 300, and the sun are optically aligned. As shown in FIG. 6B, if the sun, subject, and electronic device 300 are optically aligned, a backlight condition is identified and an amount of sunlight entering the camera 321 may be measure with the illumination sensor 351. The shooting location obtaining module 311 may identify the light amount measured by the illumination sensor as the maximum value. The maximum value may be a threshold value for identifying a backlight condition later on.

The shooting location obtaining module 311 may find a location without a backlight at the outside of camera view angle with the illumination sensor 351. The shooting location obtaining module 311 may control the display module 341 to display current location information 603 (i.e., map) and recommended shooting location information 604 (i.e., information including a possible direction and a distance for shooting) together with a preview image.

While the electronic device 300 is moving to a location indicated by the recommended shooting location information 604, the processor 310 may measure a lux value by controlling the illumination sensor 351. If the lux value received from the illumination sensor 351 becomes less than the threshold value before the electronic device reaches a location indicated by the recommended shooting location information 604, the shooting location obtaining module 311 may control the display module 341 to display with a preview image a shooting possibility notice with a preview image. FIG. 6C shows a screen captured when the electronic device 300 reached the location indicated by the recommended shooting location information while the shooting location obtaining module 311 controls the display module 341.

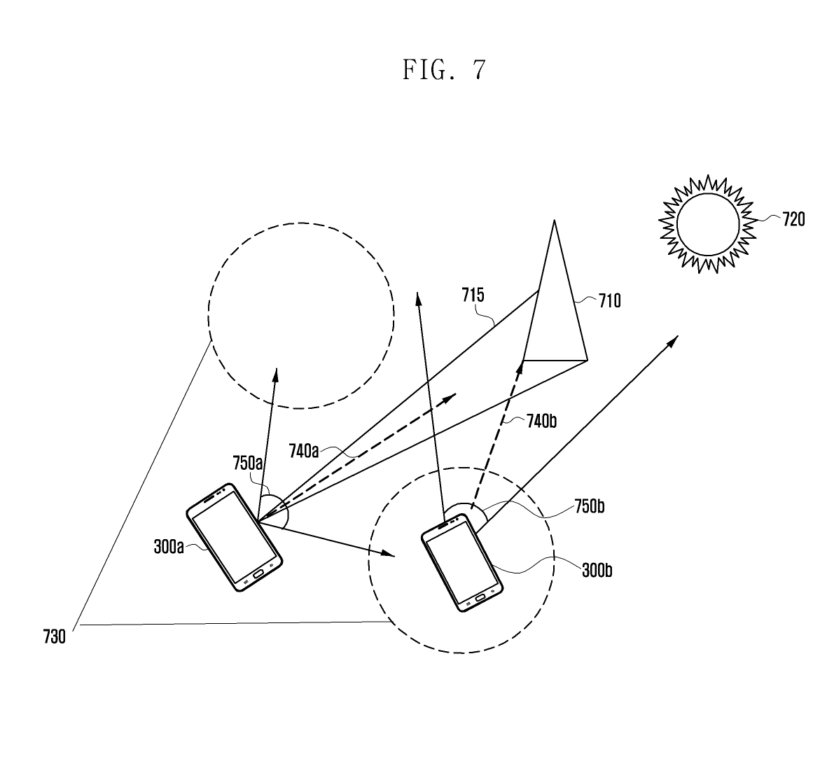

FIG. 7 is a drawing illustrating a method for displaying a shooting location according to various embodiments of the present disclosure.

FIG. 7 shows a method for changing a location of an electronic device according to the locations of the Sun 720 and a subject 710. The electronic device 300a may be optically aligned with the subject 710 and the Sun 720. The location manager 312 of the electronic device 300a may receive a radio signal for measuring a location from a GPS satellite (not shown). The location manager 312 may identify the current location of the electronic device 300a by using the radio signal.

The sensor manager 313 of the electronic device 300a may identify an orientation 740a of the electronic device 300a by controlling the gyroscope sensor 352 and orientation sensor 353 of the sensor unit 350. Further, the camera of the electronic device 300a may have a view angle 750a. The subject 710 located between the electronic device 300a and the Sun 720 may have a shadow 715. The sensor manager 313 of the electronic device 300a may measure lux values of light received from the Sun 720 and light reflected by the subject 710 within the camera view angle 750a.

The electronic device 300a may identify the lux value of the Sun 720 as the maximum value. The maximum value may be a threshold value for identifying a backlight condition later on. The electronic device 300a may decide shooting by comparing the lux value of the sun 720 and the threshold value. An image obtaining module of the electronic device 300a may decide that the lux value of the sun 720 is greater than the threshold value. The shooting location obtaining module 311 of the electronic device 300a may find an optimal location 730 (i.e., a location without a backlight) for shooting the subject 710 at the outside of a view angle 740a by using the location and orientation data of the electronic device 300a, Sun 720, and subject 710.

The shooting location obtaining module 311 may control the display module 341 to display recommended shooting location information for guiding a location without a backlight together with a preview image. While the electronic device 300 is moving to a location indicated by the recommended shooting location information 604, the sensor manager 313 may measure a lux value of the sun 720 by controlling the illumination sensor 351.

If the lux value of the sun 720 received from the illumination sensor 351 becomes less than the threshold value while the electronic device 300a reaches the location indicated by the recommended shooting location information, the shooting location obtaining module 311 may control the display module 341 to display a shooting possibility notice with a preview image. Therefore, the electronic device 300b located at an optimal location 730 indicated by the shooting location obtaining module 311 may shoot the subject 710 without a backlight by controlling the camera 321.

The method for guiding a shooting location of an electronic device according to various embodiments of the present disclosure may include: shooting a subject with a camera of the electronic device; identifying whether an amount of incident light measured by a sensor of the camera is greater than a predetermined threshold value; and displaying recommended shooting location information with a preview image if the amount of incident light is greater than the predetermined threshold value.

The apparatuses and methods of the disclosure can be implemented in hardware, and in part as firmware or as machine executable code in conjunction with hardware that is stored on a non-transitory machine readable medium such as a CD ROM, a RAM, a floppy disk, a hard disk, or a magneto-optical disk, or computer code downloaded over a network originally stored on a remote recording medium or a non-transitory machine readable medium and stored on a local non-transitory recording medium for execution by hardware such as a processor, so that the methods described herein are loaded into hardware such as a general purpose computer, or a special processor or in programmable or dedicated hardware, such as an ASIC or FPGA. As would be understood in the art, the computer, the processor, microprocessor, controller, control unit or other programmable hardware include memory components, e.g., RAM, ROM, Flash, etc. that may store or receive machine or computer executable code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” “controller”, or “control unit” or “microcontroller” constitute hardware in the claimed disclosure that contain circuitry that is configured for operation with machine executable code or firmware. Under the broadest reasonable interpretation, the appended claims constitute statutory subject matter in compliance with 35 U.S.C. §101.

The definition of the terms “unit” or “module” as referred to herein is to be understood as constituting hardware circuitry such as a processor or microprocessor configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and does not constitute software per se or pure software. Nor is the claimed disclosure an Abstract idea.

Examples of computer-readable media include: magnetic media, such as hard disks, floppy disks, and magnetic tape; optical media such as Compact Disc Read Only Memory (CD-ROM) disks and Digital Versatile Disc (DVD); magneto-optical media, such as floptical disks; and hardware devices that are specially configured to store and perform program instructions (e.g., programming modules), such as read-only memory (ROM), random access memory (RAM), flash memory, etc. Examples of program instructions include machine code instructions created by assembly languages, such as a compiler, and code instructions created by a high-level programming language executable in computers using an interpreter, etc. The described hardware devices may be configured to act as one or more modules in order to perform the operations and methods described above, or vice versa. Modules or programming modules according to the embodiments of the present disclosure may include one or more components, remove part of them described above, or include new components. The operations performed by modules, programming modules, or the other components, according to the present disclosure, may be executed in serial, parallel, repetitive or heuristic fashion. Part of the operations may be executed in any other order, skipped, or executed with additional operations.

Although exemplary embodiments of the disclosure have been described in detail above, it should be understood that many variations and modifications of the basic inventive concept herein described, which may be apparent to those skilled in the art, will still fall within the spirit and scope of the exemplary embodiments of the disclosure as defined in the appended claims.

What is claimed is:

1. A method for guiding a camera shooting location of an electronic device, the method comprising:
shooting a subject with a camera of the electronic device;
identifying whether an amount of incident light measured by a sensor of the camera is greater than a predetermined threshold value; and
displaying with a preview image a recommended shooting location information identifying at least one location at which to shoot an image of a subject with a reduced amount of incident light being at least below the predetermined threshold value if the amount of incident light at a current location is greater than the predetermined threshold value.

2. The method of claim 1, wherein the shooting a subject comprises performing a shooting operation after identifying a selection of a subject to be shot.

3. The method of claim 1 further comprising calculating a distance between the electronic device and a subject to be shot and displaying the distance with the preview.

4. The method of claim 1, wherein the identifying of at least one location at which to shoot an image of a subject comprises a location for shooting the selected subject without a backlight.

5. The method of claim 1, wherein the measuring the amount of incident light is performed after identifying whether the electronic device, subject, and Sun are optically aligned.

6. The method of claim 5, wherein the identifying whether an amount of incident light is greater than a predetermined threshold value is performed after detecting locations of the Sun, subject, and electronic device.

7. The method of claim 1, wherein the displaying with the preview image the recommended shooting location information comprises identifying locations of the electronic device, the subject, and the Sun in an outer range of camera's view angle.

8. The method of claim 7, wherein the displaying recommended shooting location information comprises displaying at least one of a direction and a distance to move towards the recommended location.

9. The method of claim 1, wherein the displaying recommended shooting location information comprises displaying with the preview image a map indicating a shooting location of the electronic device.

10. The method of claim 1, wherein the displaying recommended shooting location information further comprises displaying with the preview image a shooting probability notice if the light amount becomes less than the threshold value.

11. An apparatus for guiding a camera shooting location of an electronic device, the apparatus comprising:
an input unit including a camera in the electronic device configured to shoot a subject;
a memory including an application configured to drive the camera;
a display unit including a display module configured to display a shooting location of the subject;
a sensor unit including an illumination sensor configured to measure a sunlight amount, and a gyroscope sensor and an orientation sensor configured to measure a shooting direction of the camera; and
a processor configured to control a wireless communication unit including a GPS for measuring the locations of the electronic device, subject, and sun,
wherein the processor includes a shooting location obtaining module which shoots a subject with the camera of the electronic device, identifies whether an amount of incident light measured by a sensor of the camera is greater than a predetermined threshold value, and controlling to display recommended shooting location information with a preview image if the incident light amount is greater than the predetermined threshold value.

12. The apparatus of claim 11, wherein the processor controls shooting the subject after identifying a selection of a subject to be shot.

13. The apparatus of claim 11, wherein the processor controls shooting the subject after identifying whether the electronic device, the subject, and the sun are optically aligned.

14. The apparatus of claim 11, wherein the processor identifies after detecting the locations of the sun, the subject, and the electronic device.

15. The apparatus of claim 11, wherein the processor controls to display with the preview image the recommended shooting location information by identifying from the locations of the electronic device, subject, and Sun in an outer range of camera's view angle.

16. The apparatus of claim 15, wherein the processor controls displaying recommended shooting location information including a moving direction and a distance toward the recommended location.

17. The apparatus of claim 13, wherein the processor further controls to display with the preview image a map indicating a shooting location of the electronic device.

18. The apparatus of claim 11, wherein the processor further controls a display of the preview image with a shooting probability notice if the light amount becomes less than the threshold value.

19. The apparatus of claim 11, wherein the processor is further configured to calculate a distance between the electronic device and a subject to be shot and display the distance with the preview.

20. The apparatus of claim 11, wherein processor is configured to identify at least one location at which to shoot an image of a subject that comprises a location for shooting the selected subject without a backlight.
